(19) United States
(12) Patent Application Publication
(10) Pub. No.: US 2014/0297758 A1
(43) Pub. Date: Oct. 2, 2014

(54) EVENT NOTIFICATIONS BASED ON LEARNED TRAVELING TIMES BETWEEN LOCATIONS

(71) Applicant: HEWLETT-PACKARD DEVELOPMENT COMPANY, L.P., (US)

(72) Inventors: Adi Kidron, Tel-Aviv (IL); Erez Yaary, Tel-Aviv (IL); Yael Keren, Tel-Aviv (IL); Oded Klimer, Petach Tiqva (IL)

(73) Assignee: HEWLETT-PACKARD DEVELOPMENT COMPANY, L.P., Houston, TX (US)

(21) Appl. No.: 13/850,865

(22) Filed: Mar. 26, 2013

(51) Int. Cl. H04L 12/58

(52) U.S. Cl. CPC H04L 51/00
USPC 709/206

(57) ABSTRACT

Example embodiments relate to event notifications based on learned traveling times between locations. In some examples, a scheduling server computing device may determining an estimated travel time between a first location and a second location based on actual travel times of client devices between the first location and the second location. A scheduling server may determine a location of an event attendee based on location information received from a client device associated with the event attendee. A scheduling server may determine a location of an event and an event time based on an event object. If the location of the attendee is approximately the same as the first location and the location of the event is approximately the same as the second location, a scheduling server may communicating an event notification to the attendee based on the event time and the estimated travel time.

### BACKGROUND

Various calendar software programs may provide users with an electronic or digital version of a calendar. These software programs may also provide an address book and/or a contact list of persons who can be added as attendees of an appointment, and they may provide a list of appointments and attendees for each appointment. These software programs may send appointment notifications or reminders to attendees of an appointment to remind the attendees of an upcoming appointment. Regarding implementation, these software programs may be a local package designed for individual use or may be a server-based package that allows users to access the electronic calendar via a network (e.g., and via an exchange server). These software programs may also allow users to share information with other users of the calendar program. In some scenarios, users may access a server-based calendar via a client device (e.g., a desktop computer or mobile device such as a smartphone, tablet, PDA or the like).

### BRIEF DESCRIPTION OF THE DRAWINGS

The following detailed description references the drawings, wherein:

FIG. 1 is a block diagram of an example scheduling server computing device for generating event notifications based on learned traveling times between locations;

FIG. 2 is a block diagram of an example client computing device for facilitating the generation and receipt of event notifications based on learned traveling times between locations;

FIG. 3 is a block diagram of an example scheduling server computing device for generating event notifications based on learned traveling times between locations;

FIG. 4 is a block diagram of an example client computing device for facilitating the generation and receipt of event notifications based on learned traveling times between locations;

FIG. 5A is a flowchart of an example method for generating event notifications based on learned traveling times between locations;

FIG. 5B is a flowchart of an example method for facilitating the generation and receipt of event notifications based on learned traveling times between locations;

FIG. 6A is a flowchart of an example method for generating event notifications based on learned traveling times between locations;

FIG. 6B is a flowchart of an example method for facilitating the generation and receipt of event notifications based on learned traveling times between locations;

FIG. 7A is a diagram of an example user interface that may be displayed on a device display of a client device;

FIG. 7B is a diagram of an example user interface that may be displayed on a device display of a client device; and

FIG. 8 is a diagram of an example notification that may be displayed on a device display of a client device.

### DETAILED DESCRIPTION

As described above, various calendar software programs may send appointment notifications to attendees of an appointment to remind attendees of an upcoming appointment. Various calendar software programs send appointment notifications at fixed time periods before the appointment time (e.g., 15 minutes prior to the appointment, 5 minutes prior, etc.). In some scenarios, these fixed-time appointment notifications may not be particularly useful to an attendee of an appointment. For example, if an attendee is located in the attendee's work cubical which is very close to a meeting room where an appointment is to take place, the attendee may not care to receive a 15-minute notification because it may take the attendee approximately 30 seconds to walk to the meeting room. As another example, suppose an attendee is invited to two back-to-back meetings and the attendee is in the first meeting room, which is a 7-minute walk to the second meeting room. In such a case, instead of a fixed 15-minute notification, it may be more useful for the attendee to receive an 8-minute notification, for example, to allow the attendee 1 minute to wrap up what the attendee is doing in the first meeting and 7 minutes to walk to the second meeting room.

Various calendar software programs may attempt to use the GPS location (e.g., using satellites) and the rate of motion of a device (e.g., a phone) to determine whether the user (e.g., a user traveling in a car) is likely to arrive at an appointment on time. Such calendar software programs may then determine whether to cancel or postpone a pre-determined appointment reminder. Various other calendar software programs may attempt to generate event reminders when a mobile computing device location matches a target location. Among other things that these calendar software programs lack, they do not learn actual travel times of users between event locations to determine an accurate estimated travel time to an event for an event attendee.

The present disclosure describes generating event notifications based on learned traveling times between locations. In some examples, a scheduling server computing device may determining an estimated travel time between a first location and a second location based on actual travel times of client devices between the first location and the second location. A scheduling server may determine a location of an event attendee based on location information received from a client device associated with the event attendee. A scheduling server may determine a location of an event and an event time based on an event object. If the location of the attendee is approximately the same as the first location and the location of the event is approximately the same as the second location, a scheduling server may communicating an event notification to the attendee based on the event time and the estimated travel time.

The present disclosure may provide benefits over various calendar software programs that send reminders at default or fixed times. Instead, the present disclosure describes sending notifications at smart times based on where attendees are located, where attendees are supposed to be in the future, and estimated travel times based on crowd sourcing of actual travel times observed between the same or similar locations in the past. In this respect, notifications are made more accurate and are tailored to each particular user. Additionally, the present disclosure describes the ability for users to send one-touch responses to event notifications, which may result in automatic messaging being sent to the correct people related to the event (e.g., the organizer). The present disclosure may allow event notifications to be more accurate and may allow events to be conducted more efficiently. For example, an event attendee with back-to-back events may be more productive in the first event if the attendee is not being interrupted with unnecessary notifications for the next event. As another example, an event organizer may not have to waste time attempting to contact attendees to determine whether and/or when they will arrive to an event.

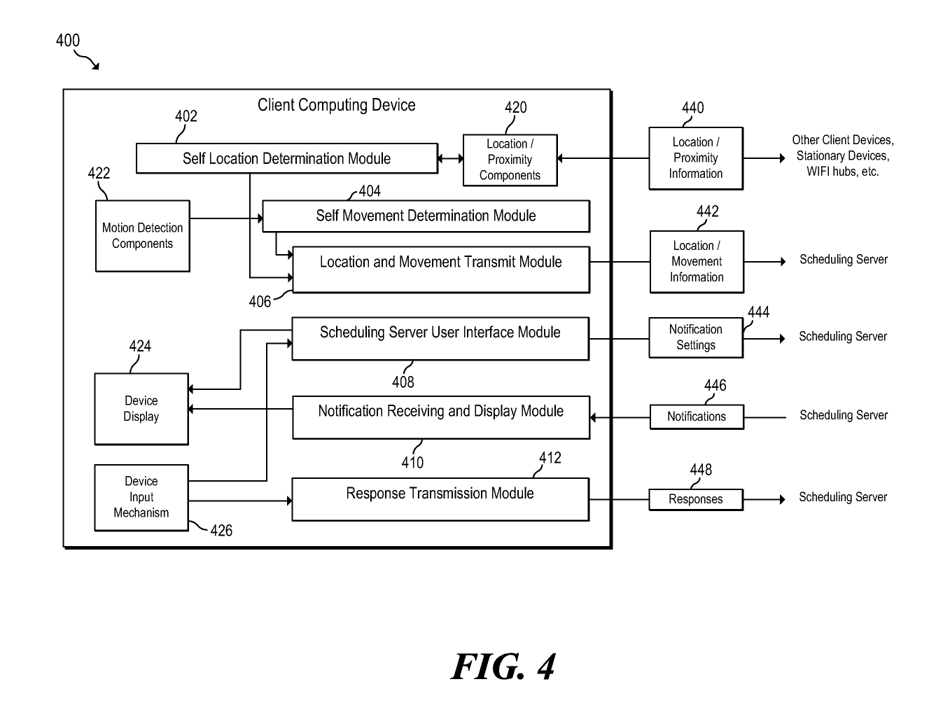

Throughout this disclosure, it should be understood how the terms “user”, “attendee” and “organizer” are related. The term “user” may refer to a person who uses a client device, for example, client computing device 200 of FIG. 2 or 400 of FIG. 4. The term “attendee” may refer to a specific type of user, wherein the user/attendee is invited to attend an event, and wherein an event object (explained in more detail below) may indicate the attendees of an event. The term “organizer” may refer to a specific type of user, wherein the user/organizer creates the event object and/or presents, runs or organizes the event, and wherein the event object may indicate the organizer of the event. Throughout this disclosure, it should be understood that the term “client device” may be used as a shorthand term or a more generalized term for “client computing device.” Likewise, the term “scheduling server” may be used as a shorthand term or a more generalized term for “scheduling server computing device.” For the purposes of this disclosure, the term “event” may refer to an appointment or meeting, a test appointment or meeting, a web-based appointment or meeting (e.g., the attendees may be located at a desk, cubical, at home, etc.), the absence of an appointment or meeting (e.g., the attendees may be located at a desk, cubical, at home, in the car, on the train, etc.), or any other event where the location of a client device can be determined as a travel start time or a travel end time. Throughout this disclosure, it should be understood that the term “approximately” or “approximate” as it relates to one location (or device or person) being near another location (or device or person) should be understood to mean within a distance range, for example, within 5 feet, within 10 feet, within 15 feet, within 20 or the like.

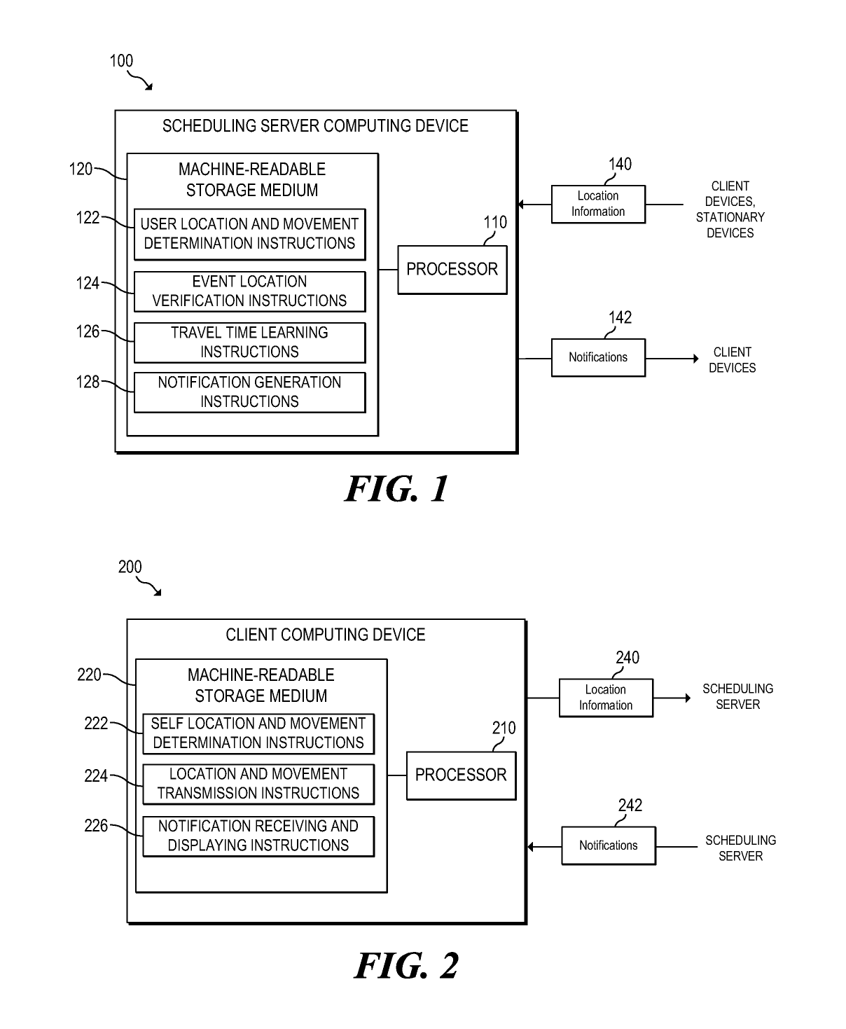

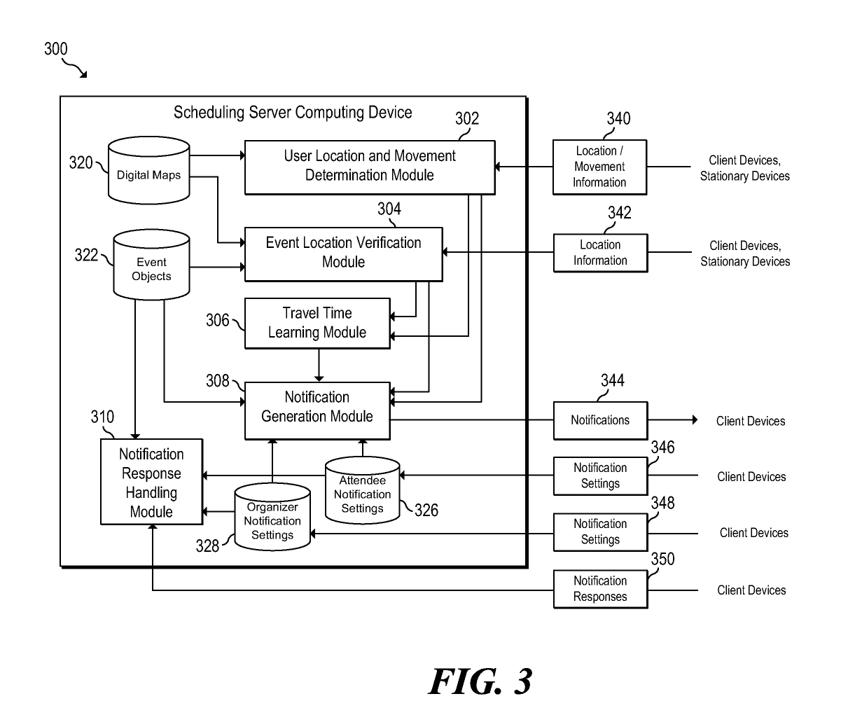

FIG. 1 is a block diagram of an example scheduling server computing device 100 for generating event notifications based on learned traveling times between locations. Scheduling server computing device 100 may be any computing device accessible to at least one client device, such as client computing device 200 of FIG. 2 or 400 of FIG. 4. Scheduling server computing device 100 may be in communication with at least one client device via a network, for example, the internet, an intranet or other type of network. More details regarding an example scheduling server computing device may be described below with respect to scheduling server computing device 300 of FIG. 3. In the embodiment of FIG. 1, scheduling server computing device 100 includes a processor 110 and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126, 128 to generate event notifications based on learned traveling times (e.g., of at least one client computing device) between locations. As an alternative or in addition to retrieving and executing instructions, processor 110 may include one or more electronic circuits comprising a number of electronic components for performing the functionality of one or more of instructions 122, 124, 126, 128. With respect to the executable instruction representations (e.g., boxes) described and shown herein, it should be understood that part or all of the executable instructions and/or electronic circuits included within one box may, in alternate embodiments, be included in a different box shown in the figures or in a different box not shown.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. Machine-readable storage medium 120 may be disposed within scheduling server computing device 100, as shown in FIG. 1. In this situation, the executable instructions may be “installed” on the device 100. Alternatively, machine-readable storage medium 120 may be a portable (e.g., external) storage medium, for example, that allows scheduling server computing device 100 to remotely execute the instructions or download the instructions from the storage medium. In this situation, the executable instructions may be part of an installation package. As described in detail below, machine-readable storage medium 120 may be encoded with executable instructions for generating event notifications based on learned traveling times between locations.

User location and movement determination instructions 122 may determine the location and/or movement of at least one client device. User location and movement determination instructions 122 may receive location information 140 (and/or movement information) from at least one client device (e.g., client computing device 200). User location and movement determination instructions 122 may receive location information 140 from at least one stationary device (described in more detail below). Location information 140 may include information about the location of at least one client device, for example, in relation to a digital map (described in more detail below). User location and movement determination instructions 122 may determine a user location in relation to such a digital map by considering location information 140 received from at least one client device and/or at least one stationary device. More details regarding an example user location and movement determination module may be described below with respect to module 302 of FIG. 3.

Event location verification instructions 124 may determine the location of at least one event. Event location verification instructions 124 may receive event location information from at least one event object (described in more detail below). Event location verification instructions 124 may receive location information 140 from at least one client device and/or at least one stationary device. Event location verification instructions 124 may use location information 140 to determine the location of an event and/or to verify the location of an event by cross-referencing location information 140 with location information received from at least one event object. More details regarding an example event location determination module may be described below with respect to module 304 of FIG. 3.

Travel time learning instructions 126 may determine estimated travel times between various locations based on actual travel time(s) of at least one client device (e.g., client computing device 200) between the same (or approximately the same) various locations. Travel time learning instructions 126 may receive user location information (e.g., from instructions 122) and may receive event location information (e.g., from instructions 124). Travel time learning instructions 126 may learn the actual time that it takes at least one client device to travel between various locations. More details regarding an example travel time learning module may be described below with respect to module 306 of FIG. 3.

Notification generation instructions 128 may generate at least one notification of an upcoming event. Notification generation instructions 128 may receive information about an event from an event object (explained in more detail below). Notification generation instructions 128 may receive user location information about at least one user (e.g., from instructions 122). Notification generation instructions 128 may receive event location information about at least one event (e.g., from instructions 124). Notification generation instructions 128 may receive at least one estimated travel time (e.g., from instructions 126). Based on the location of a user, the location of an event, and an estimated travel time between these two locations, notification generation instruction 128 may generate a notification for the attendee. Notification generation instruction 128 may cause the notification 142 to be transmitted to a client device associated with the attendee at a time that is useful to the attendee. More details regarding an example notification generation module may be described below with respect to module 308 of FIG. 3.

FIG. 2 is a block diagram of an example client computing device 200 for facilitating the generation and receipt of event notifications based on learned traveling times between locations. Client computing device 200 may be, for example, a notebook computer, a desktop computer, an all-in-one system, a thin client, a workstation, a tablet computing device, a mobile phone, or any other computing device suitable for execution of the functionality described below. Client computing device 200 may communicate with at least one scheduling server computing device (e.g., scheduling server computing device 100 of FIG. 1) to transmit, among other things, location information, and receive, among other things, event notifications based on learned traveling times between locations. In the embodiment of FIG. 2, client computing device 200 includes processor 210 and machine-readable storage medium 220.

As with processor 110 of FIG. 1, processor 210 may be one or more CPUs, microprocessors, and/or other hardware devices suitable for retrieval and execution of instructions. Processor 210 may fetch, decode, and execute instructions 222, 224, 226 to facilitate the generation of and receive event notifications based on learned traveling times between locations, as described in more detail below. Processor 210 may also or instead include electronic circuitry for performing the functionality of one or more instructions 222, 224, 226. With respect to the executable instruction representations (e.g., boxes) described and shown herein, it should be understood that part or all of the executable instructions and/or electronic circuits included within one box may, in alternate embodiments, be included in a different box shown in the figures or in a different box not shown. As with storage medium 120 of FIG. 1, machine-readable storage medium 220 may be any physical storage device that stores executable instructions.

Self-location and movement determination instructions 222 may determine the location of the client computing device 200, for example, in relation (e.g., proximity) to other client devices and/or other stationary devices. Stationary devices may be explained in more detail below. Self-location and movement determination instructions 222 may communicate (e.g., via at least one internal component) with at least one other device (e.g., another client device or a stationary device) to determine the location (e.g., proximity) of the client computing device 200 in relation to the other device(s). In some examples, self-location and movement determination instructions 222 may communicate with multiple other devices to determine a more accurate location of the client computing device 200. Via at least one internal component, self-location and movement determination instructions 222 may determine whether client computing device 200 is in motion or is still. More details regarding an example self-location determination module and a self-movement determination module may be described below with respect to modules 402 and 404 of FIG. 4.

Location and movement transmission instructions 224 may transmit location information 240 (and/or movement information) to a scheduling server (e.g., scheduling server computing device 100). The scheduling server may use the location information 240 to determine the location of the user, for example, in relation to a digital map. More details regarding an example location and movement transmission module may be described below with respect to module 406 of FIG. 4.

Notification receiving and displaying instructions 226 may allow client computing device 200 to receive notifications 242 from a scheduling server. Notifications 242 may be formatted according to notification settings, for example, remotely-stored or locally-stored notification settings, as explained in more detail below. Notification receiving and displaying instructions 226 may display notifications to a user, e.g., via a device display integrated into or accessible to the client device. More details regarding an example notification receiving and displaying module may be described below with respect to module 410 of FIG. 4. Additionally, more details regarding the formatting (e.g., according to notification settings) and displaying of notification may be explained in more detail below.

FIG. 3 is a block diagram of an example scheduling server computing device 300 for generating event notifications based on learned traveling times between locations. Scheduling server computing device 300 may be similar to scheduling server computing device 100 of FIG. 1, for example. Scheduling server computing device 300 may be any computing device accessible to a client device over the Internet or some other network. In some embodiments, scheduling server computing device 300 may actually be more than one computing device. In other words, the components shown in computing device 300 (e.g., modules, repositories, inputs, outputs, etc.) may, but need not, be distributed across multiple computing devices, for example, computing devices that are in communication with each other via a network. In these embodiments, the computing devices may be separate devices, perhaps geographically separate. Such a distributed computing environment may be referred to as a scheduling system, such as a cloud, data center or the like.

As illustrated in FIG. 3 and described herein, scheduling server computing device 300 may communicate with at least one client computing device (e.g., client computing device 400 of FIG. 4) to transmit event notifications to the client device(s) based on learned traveling times between locations and/or to receive event notification responses from the client device(s). Scheduling server computing device 300 may also communicate with at least one stationary device, as explained in more detail below.

As illustrated in FIG. 3, scheduling server computing device 300 may include a number of modules 302, 304, 306, 308, 310. Each of these modules may include a series of instructions encoded on a machine-readable storage medium and executable by a processor of the scheduling server computing device 300. In addition or as an alternative, each module may include one or more hardware devices including electronic circuitry for implementing the functionality described below. With respect to the modules described and shown herein, it should be understood that part or all of the executable instructions and/or electronic circuitry included within one module may, in alternate embodiments, be included in a different module shown in the figures or in a different module not shown. Scheduling server computing device 300 may include a number of repositories 320, 322, 326, 328. The term repository may generally refer to a data store that may store digital information. Each of these repositories may include or be in communication with at least one physical storage mechanism (e.g., hard drive, solid state drive, tap drive or the like) capable of storing information including, for example, a digital database, a file capable of storing text, media, code, settings or the like, or other type of data store.

User location and movement determination module 302 may determine the location and/or movement of at least one client device. User location and movement determination module 302 may receive location information 340 from at least one client device (e.g., client computing device 200 or 400). User location and movement determination module 302 may receive location information 340 from at least one stationary device. Location information 340 may include information about the location of at least one client device, for example, in relation to a digital map. Location information 340 may include a series of location data points. In other words, location information 340 may be a stream of information such that the location of the client device(s) is updated in real time as the client device(s) move. User location and movement determination module 302 may determine a user location in relation to such a digital map by considering location information 340 received from at least one client device and/or at least one stationary device.

User location and movement determination module 302 may receive or access at least one digital map, for example, stored in digital map repository 320. A digital map may be essentially a blueprint for at least one building or portion of a building and/or areas surrounding at least one building. A digital map may include information about various buildings, floors, rooms, hallways, doors and the like. A digital map may include information about the locations, sizes and dimensions of these various buildings, floors, rooms, hallways, doors and the like. A digital map may include coordinated room numbers or other tracking information for rooms. A digital map may be used to determine feasible routes that can be traveled (e.g., by a human or vehicle) between various locations in the digital map. A digital map may be used to determine distances between various locations in the digital map, for example, distances of feasible travel routes. A digital map may be associated with or modeled after an actual building or portion of a building. User location and movement determination module 302 may reference a digital map and associate received location information (e.g., 340) with the digital map to determine a location of a device in relation to the digital map, and in turn in relation to the associated actual building.

A digital map may include the location of at least one stationary device. A stationary device may be a device that typically, once installed, stays in the same place day to day. Examples of stationary devices, without limitation, are printers, fax machines, projectors, conference tables, room walls and doors, security cameras, and the like. Stationary devices may include a location/proximity component that is capable of detecting other devices and/or is capable of making itself known to other devices, for example, client devices that also include a location/proximity component. Similarly, client devices (e.g., client devices 200 and/or 400) may include a location/proximity component that is capable of detecting other devices and/or is capable of making itself known to other devices, for example, other client devices and/or stationary devices. These location/proximity components may emit a signature that indicates the identity of the associated device. In this respect, when a first device receives a signal from a second device, the first device may know that it is near the second device. Location/proximity components and related technologies may be described in more detail below with regard to FIG. 4.

The following provides one example scenario that describes how client devices and stationary devices (and potentially other devices) may be used to determine the location of a client device associated with a user. In one example scenario, a user with a client device is located in a meeting room. The meeting room includes a projector (a stationary device), and a security camera is located across the hall from the meeting room (a stationary device). A digital map may include information about the precise location of the projector (e.g., in the top center of the meeting room) and the security camera. The digital map may also include information about the precise location and dimensions of the meeting room, the hallway, etc. A location/proximity component in the client device may detect a signal emitted from a location/proximity component in the projector, and may detect a signal emitted from the security camera as well. Additionally, the client device may detect the distance (proximity) between the client device and the projector, and the client device and the security camera. The client device may then transmit this location information (e.g., proximity to stationary devices with known signatures) to a scheduling server. The scheduling server may then reference the digital map and determine, within an error range, the location of the client device.

As another example, a client device may be connected to a particular WiFi hub that provides wireless internet access to an area encompassing the meeting room. The client device may know that it is connected to this particular hub, and the digital map may include information about the precise location of the hub. In this respect, if the client device transmits this location information (e.g., within the range of a particular WiFi hub) to the scheduling server, the scheduling server may have another data point to increase the accuracy of the location of the device/user. It should be understood that these are just some examples, and various other devices and technologies may be used to determine the location of a client device, for example, GPS technologies that use satellites and/or other indoor GPS technologies.

User location and movement determination module 302 may also receive movement information 340 from at least one client device (e.g., client computing device 400). Movement information 340 may be generated by a motion detection component in the client device, as explained in more detail below. Movement information 340 may indicate whether the client device is still or whether the client device is in motion. Movement information 340 may indicate whether a user is currently making progress toward a next event location, or whether the user is stopped (e.g., stopped temporarily, talking to a co-worker). User location and movement determination module 302 may track and store location and movement information 340 (e.g., indexed by timestamps) such that this information can be used by other modules of the scheduling server computing device 300.

Event location verification module 304 may determine and/or verify the location of event (e.g., dynamically, in real time). Event location verification module 304 may receive or access event location information and attendee information from at least one event object (e.g., stored in event object repository 322). The term “event object” may refer to a digital record or file that includes information about an event. An event object may include a subject or title, a date of the event, an event location, invited attendees to the event, an organizer of the event (may be considered an attendee as well), and potentially other details about the event. An event object may be accessible by various devices and users, for example, via a network. Event location verification module 304 may access at least one digital map (e.g., in digital map repository 320) to look up the digital map location of the event. Event location verification module 304 may attempt to verify the location of an event, for example, by cross referencing the event location information from the associated event object and digital map with attendees of the event and location information (e.g., location information 342) from client devices and/or stationary devices.

The following provides one example scenario that describes how client devices and stationary devices (and potentially other devices) may be used to verify the location of an event location. In one example scenario, an event object indicates that the event is to take place in Room C, and that attendee 1, attendee 2 and attendee 3 are to be at the associated event. By accessing the event object (and a digital map), a scheduling server may start by assuming that Room C is the correct event location. As the event time draws near, the scheduling server may use location information from client devices and/or stationary devices to confirm that Room C is correct. For example, a first user (e.g., attendee 1) with a first client device is located in Room C. This may be known, for example, because a location/proximity component in the first client device sensed at least one stationary device in or near Room C (as explained above). Additionally, a second user (e.g., attendee 2) with a second client device is located in Room C. The first and second client devices may transmit their location information to the scheduling server, and the scheduling server may confirm within a degree of confidence that the meeting is in Room C. If on the other hand, the scheduling server received information that several attendees of the meeting were located in a different room, then the event location verification module 304 may set (e.g., internally) the meeting location to the revised location. This revised location may be used to calculate travel times (e.g., in module 306) and to notify attendees of the meeting (e.g., via module 308). It should be understood that this is just one example, and various other devices (e.g., WiFi hubs) and technologies may be used to verify the location of an event, for example, GPS technologies that use satellites and/or other indoor GPS technologies.

Travel time learning module 306 may determine estimated travel times between various locations based on actual travel time(s) of at least one client device (e.g., client computing device 400) between the same (or approximately the same) various locations. The term “travel” should be interpreted, throughout this disclosure, to cover various types and ranges of travel or movement. For example, the term travel may refer to movement over longer distances (e.g., a user driving in a car). As another example, the term travel may refer to movement over shorter distances (e.g., a user walking indoor, between rooms, etc.). As another example, the term travel may refer to a combination of various types and ranges of travel (e.g., longer-range traveling in a car, followed by shorter-range walking indoors).

Travel time learning module 306 may receive user location information (e.g., from module 302) and may receive event location information (e.g., from module 304). Travel time learning module 306 may use the user location information and the event location information to determine the location and movement of users between various locations. Travel time learning module 306 may track and/or store data about the movement of users between various locations such that the data may be analyzed to learn the time it takes various users to move between various locations. In this respect, travel time learning module 306 may learn the actual time that it takes at least one client device to travel between various locations. In some examples, travel time learning module 306 may learn the actual time that it takes multiple client devices to travel between various locations (e.g., where the multiple client devices travel, at least in part, between the same locations). Travel time learning module 306 may consider multiple travel times from the multiple client devices to compute a single “typical” travel time (e.g., by performing an average calculation or some other aggregation and/or normalization calculation) between two locations. In this respect, typical travel times may be computed based on previous user travel times in a crowd sourcing manner. Travel time learning module 306 may determine estimated travel times based on these typical travel times. Estimated travel times may be used to generate notifications (e.g., notifications 344) to attendees of events.

The following provides one example scenario that describes how a travel time learning module may use location information of users and location information of events to learn actual travel times. A first meeting may start at 9 AM in Room A, and a second meeting may start at 10 AM in Room B. Previous to these meetings, the travel time learning module may have received location information from users that were located in or near Room A (e.g., for a previous meeting, test meeting or other event). In some examples, travel time learning module may have received information confirming that an event was taking place in Room A as well. The travel time learning module may have then received information that these users moved (e.g., walked) to Room B. The travel time learning module may determine how long it takes each user to travel between Room A and Room B. Over time, the travel time learning module may generate a collection of data regarding various travel times between Room A and Room B. The travel time learning module may use this collection of data to determine a typical travel time, for example by computing an average of travel times. It should be understood that, to create such a collection of data, the travel time learning module may use information regarding users traveling between actual meetings and/or users that just happen to be traveling between locations where meetings take place.

In some embodiments, travel time learning module 306 may receive user movement information (e.g., from module 302). Movement information may indicate whether a user/client device is in motion (e.g., walking), or is still (e.g., stand and talking to a co-worker). In order to collect data that is indicative of actual travel times between locations, the travel time learning module 306 may use movement information to increase the accuracy of travel times. For example, if a user starts traveling between a first location and a second location, and then stops moving for a period of time, the travel time learning module may adjust the travel time to account for this stopping time (e.g., by subtracting the stopping time from the total travel time). In some examples, the travel time learning module may receive information about the locations of other attendees to an event in relation to the event location to confirm that a stopping time is an intermediary point and not, for example, the next event location.

Notification generation module 308 may generate at least one notification of an upcoming event. Notification generation module 308 may receive information about an event from an event object. Notification generation module 308 may receive user location information about at least one user (e.g., from module 302). Notification generation module 308 may receive event location information about at least one event (e.g., from module 304). Notification generation module may receive at least one estimated travel time (e.g., from module 306), for example, between a first location and a second location. As one example, notification generation module 306 may determine that an event is upcoming by accessing an event object. Notification generation module 306 may determine an attendee of the event by accessing the event object. Notification generation module 306 may receive the location of the attendee and the location of the event. Notification generation module 306 may determine that the attendee location is approximately the same as the first location and the event location is approximately the same as the second location. Based on the location of the attendee, the location of the event an estimated travel time between those two locations, notification generation module 306 may generate a notification for the attendee.

Notification generation module 306 may cause the notification 344 to be transmitted to a client device associated with the attendee at a time that is useful to the attendee. In this respect, the scheduling server may automatically generate and transmit notifications of events to attendees, where the notifications are tailored to the specific situation of the attendee (e.g., distance from event and travel time required to get to the event). This may offer an improvement over calendar systems that generate reminders at default or fixed times. Instead, notifications are sent at the most useful time for each particular attendee. As one specific example, the scheduling server may cause a notification to display on the display of a device that reads: “Your next meeting is about to start (in 8 minutes), and it will take you 7 minutes to walk there. You better wrap up!”

In some embodiments, notification generation module 308 may receive location information from at least one client device in order to make smart decisions about whether notification should be transmitted to a client device or, in the case of a user with multiple client devices, which client device to transmit the notification to. For example, if a user has a smartphone and a tablet, the scheduling server may detect that the tablet is at the user's desk, and the smartphone is likely on the user's person (e.g., because it is moving around an office building). In this example, notification generation module 308 may transmit a notification to the smartphone and refrain from transmitting a notification to the user's tablet. As another example, if a user forgot the user's client device at home, the scheduling server may detect that the smartphone has not been in the building all day and has been stationary all day. In this example, notification generation module 308 may refrain from transmitting a notification to the user's client device.

Notification generation module 308 may access notification settings, for example, via at least one notification settings repository (e.g., repositories 326 and/or 328). Notification settings may be stored in the scheduling server computing device 300 (e.g., in repositories 326 and/or 328). Client devices may transmit notification settings (e.g., 346 and/or 348) to the server computing device 300 for storage (e.g., in repositories 326 and/or 328). As one example, notification settings 346 may be transmitted by a client device associated with an attendee of an event, and may be stored in attendee notification setting repository 328. As another example, notification settings 348 may be transmitted by a client device associated with an organizer of an event, and may be stored in organizer notification setting repository 326. Notification generation module 308 may alter the generation and/or transmission of notifications (e.g., notifications 344) based on the notification settings. For example, timing, content, formatting and/or design (e.g., colors, images, etc.) of notifications may be affected by the notification settings.

Organizer notification settings may allow an event organizer to customize the way that notifications are generated and/or are displayed on client devices of attendees. For example, event organizers may specify rules for notifications, where the rules may depend on various conditions such as the location of attendees and the travel time required for attendees to travel to an event. One example rule may specify that if an attendee is running too late to an event (e.g., 10 or more minutes late), a notification should indicate that the attendee should not bother coming to the meeting (e.g., no unreasonably late attendees allowed).

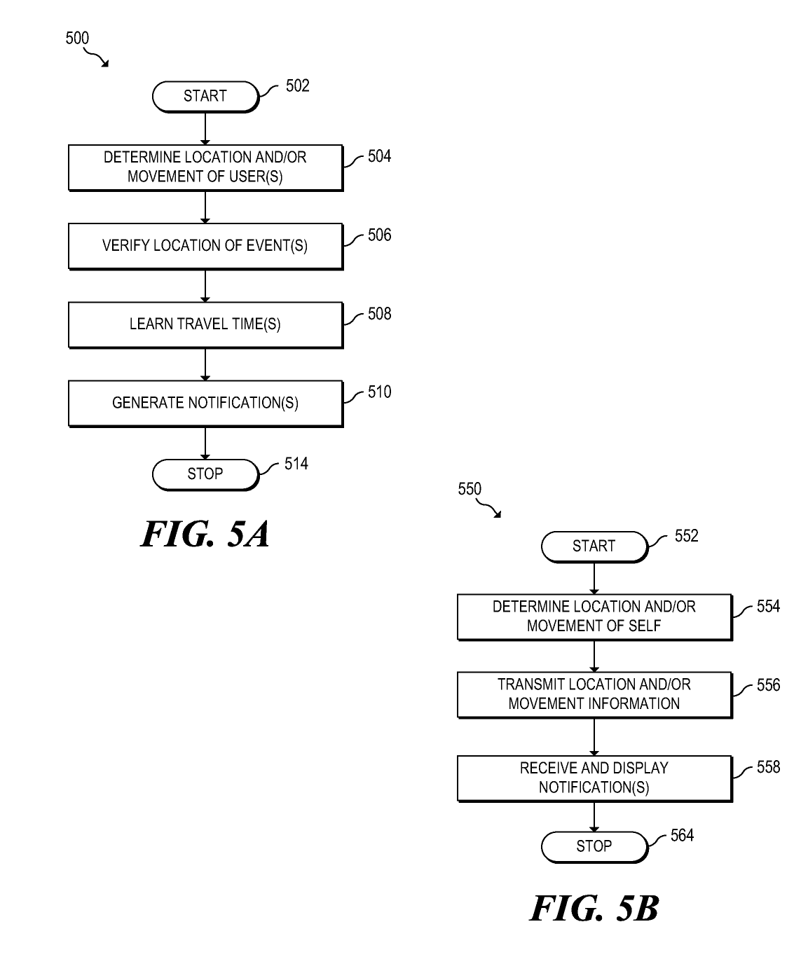

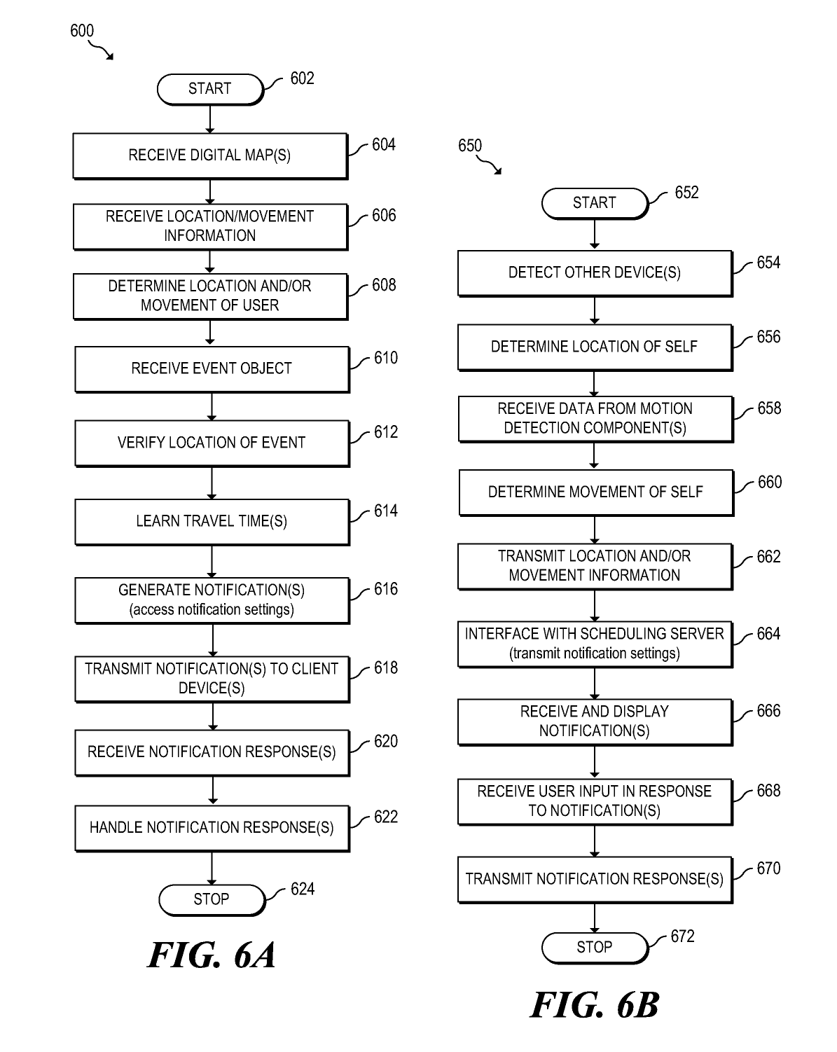

Attendee notification settings may allow event attendees to customize the way that notifications are generated and/or are display on their client devices. For example, an attendee may design a notification template for the attendee's events, and notifications for that attendee may be displayed according to the template. Attendee notification settings may specify the formatting and/or design (e.g., colors, images, etc.) of notifications. In some embodiments, attendee notification settings may specify at least one widget that should appear along with (or embedded within) the notification when it displays on the client device. One example widget may be a weather widget that shows a summary of the current weather or a forecast of the weather in the future. A weather widget may, for example, indicate to an attendee what the weather will be like if the attendee has to travel outside (e.g., between buildings) to get to a meeting. Another example widget may be a travel map and/or travel instructions, which may indicate to a user how the user should travel to the event, e.g., so that the estimated travel time can be achieved. Further details about notification settings, including widgets may be described below with regard to FIGS. 5A, 5B and 6.

Notification response handling module 310 may receive at least one notification response 350 from a client device, for example, a client device associated with an attendee of an event. As one specific example, scheduling server computing device 300 may have transmitted a notification 344 of an event to a client device associated with an attendee of the event. Then, the attendee may cause the client device to transmit a notification response 350 to the scheduling server computing device 300. The notification response 350 may indicate whether an attendee of an event has seen the notification (e.g., the attendee may have pressed an “OK” button on the attendee's client device). The notification response 350 may indicate that an attendee of an event is likely to be late for an event (e.g., the attendee may have pressed a “Running Late” button). The notification response 350 may indicate how late an attendee will be for an event, for example, based on the location of the attendee and the estimated travel time to the event.

Notification response handling module 310 may perform at least one routine based on receiving a notification response 350. For example, notification response handling module 310 may generate and/or transmit a message to at least one recipient (e.g., the organizer of an event) if the notification response 350 indicates that an attendee of the event will likely be late. Notification response handling module 310 may access notification settings (e.g., in repositories 326 and/or 328) in order to determine at least one routine that should be performed based on a notification response.

Notification response handling module 310 may alter the generation and/or transmission of messages (e.g., messages sent in response to receiving a notification response) based on the notification settings. For example, the list of recipients to receive a message may be altered by notification settings (e.g., organizer notification settings set by the organizer of an event). In this respect, an organizer of an event may specify at least one routine that will occur then an event notification response is received. In one example scenario, an organizer could specify that if an attendee is running late, a message will be sent to just the organizer or to all other attendees of the meeting. In this respect, the scheduling server may allow for automatic and dynamic messaging based on notification responses, for example, by accessing an event object 322 and determining the current organizer and attendees of an event. In this respect, an attendee may simply press a button (e.g., one-touch response) to indicate that the attendee will be late, and a message will be automatically sent to all the correct people. This may allow an attendee to avoid having to search for names of people to send a message to. Instead, the scheduling server may automatically identify the correct people and send the messages. As one additional example, if the organizer indicates (e.g., via a button on a client device) that the organizer is running late, the notification settings may specify that messages will be sent to all the attendees of the event, e.g., a message that says, “My apologies, I′m running late. I'll be there shortly!”

FIG. 4 is a block diagram of an example client computing device 400 for facilitating the generation and receipt of event notifications based on learned traveling times between locations. Client computing device 400 may be similar to client computing device 200 of FIG. 2, for example. Client computing device 200 may be, for example, a notebook computer, a desktop computer, an all-in-one system, a thin client, a workstation, a tablet computing device, a mobile phone, or any other computing device suitable for execution of the functionality described below. As illustrated in FIG. 4 and described herein, client computing device 400 may communicate with at least one scheduling server computing device (e.g., scheduling server computing device 100 of FIG. 1 or scheduling server computing device 300 of FIG. 3) to receive event notifications based on learned traveling times between locations and/or to transmit event notification responses to scheduling server computing device(s). Client computing device 400 may also communicate with at least one stationary device (and potentially with other devices such as WiFi hubs), as explained in more detail below.

As illustrated in FIG. 4, client computing device 400 may include a number of modules 402, 404, 406, 408, 410, 412. Each of these modules may include a series of instructions encoded on a machine-readable storage medium and executable by a processor of the client computing device 400. In addition or as an alternative, each module may include one or more hardware devices including electronic circuitry for implementing the functionality described below. With respect to the modules described and shown herein, it should be understood that part or all of the executable instructions and/or electronic circuitry included within one module may, in alternate embodiments, be included in a different module shown in the figures or in a different module not shown. Client computing device 400 may include a number of internal components 420, 422, 424, 426. Each of these components may be integrated in the client device or accessible by the client device. These components may provide various technologies and/or functionality to the client device.

Self-location determination module 402 may determine the location of the client computing device 400, for example, in relation (e.g., proximity) to other client devices and/or other stationary devices. Self-location determination module 402 may communicate with various internal components of the client computing device 400. Via at least one internal component (e.g., location/proximity components 420), self-location determination module 402 may communicate with at least one other device (e.g., another client device or a stationary device) to determine the location (e.g., proximity) of the client computing device 400 in relation to the other device. As explained above, in some examples, self-location determination module 402 may communicate with multiple other devices to determine a more accurate location of the client computing device 400.

Self-location determination module 402 may receive location/proximity information 440 from other devices, and/or self-location determination module 402 may emit location/proximity information 440 to other devices. As explained above, a client device (e.g., client computing device 400) may determine the client device's location in relation to a digital map by considering location information 440 received from at least one client device and/or at least one stationary device. In order to communicate with other devices (e.g., other client device and/or stationary devices), each of the client devices and the stationary devices may include at least one location/proximity component. In some examples, depending on the setup, a location/proximity component (e.g., 420) may emit signals to allow itself to be detected. In other examples, a location/proximity component may receive and detect signals emitted by other devices. These location/proximity components may be implemented as any type of location and/or proximity technology. For example, these location/proximity components may be mid-range emitters and/or sensors such as RF (Radio Frequency) emitters/sensors. As another example, these location/proximity components may be short-to-mid-range emitters/sensors such as NFC (Near Field Communication) emitters/sensors. These location/proximity components may be capable of detecting whether another device (e.g., a mobile client device) is within a certain range. These location/proximity components may be able to determine the distance to another device if the other device is within a certain range.

Self-movement determination module 404 may determine whether client computing device 400 is in motion or is still. Self-movement determination module 404 may communicate with various internal components of the client computing device 400 (e.g., motion detection components 422). Motion detection components 422 maybe, for example, an accelerometer and/or a tilt detector and/or other type of motion detection component. Via at least one internal component, self-movement determination module 404 may detect whether client computing device 400 is in motion or is still, and may transmit this information (e.g., via other modules of the client computing device 400) to a scheduling server.

Location and movement transmission module 406 may transmit location information and/or movement information 442 to a scheduling server (e.g., scheduling server computing device 100 or 300). The scheduling server may use the location information 442 to determine the location of the user, for example, in relation to a digital map. The scheduling server may use the movement information 442 to determine whether a travel time of a user between two locations includes any stopping time.

Scheduling server user interface module 408 may allow client computing device 400 to access at least one notification settings repositories (e.g., 326 and/or 328) in the scheduling server. Scheduling server user interface module 410 may allow client computing device 400 to transmit notification settings 444 to the scheduling server, for example, for storage in the at least one notification settings repositories. In some embodiments, notification settings may be stored locally in client computing device 400. In these embodiments, when notifications (e.g., notifications 446) are received from the scheduling server, the notifications may be formatted on the client computing device 400, e.g., before being displayed to a user. Scheduling server user interface module 408 may communicate with a device display 424 of the client device. For example, scheduling server user interface module 408 may transmit graphics information (e.g., windows, text, interactive menus, etc.) to the device display that may aid a user in learning about notification settings. Scheduling server user interface module 408 may communicate with a device input mechanism 426 of the client device. For example, scheduling server user interface module 408 may receive selection information (e.g., menu choices, button touches, etc.) and/or content from the device input mechanism, which may aid a user in selecting and/or setting notification settings. More details about example notification settings screens that a user may see via device display and particular settings that a user can select via device input mechanism may be discussed below with regard to FIGS. 5A and 5B.

Notification receiving and displaying module 410 may allow client computing device 400 to receive notifications 446 from a scheduling server. Notifications 446 may be formatted according to notification settings, as explained in more detail above. For example, if notification settings are stored on the scheduling server, the notification settings may be formatted at the scheduling server before being communicated to the client device. In some embodiments, notification settings may be stored locally in client computing device 400. In these embodiments, when notifications (e.g., notifications 446) are received from the scheduling server, the notifications may be formatted on the client computing device 400, e.g., before being displayed to a user. Notification receiving and displaying module 410 may display notifications to a user, e.g., via device display 424. As one example, a notification response may be displayed as a pop-up window on the display of a client device. When a notification is displayed on a client device, the notification may include a number of buttons, for example, a button that allows a user to acknowledge receive of the notification (e.g., an “OK” button) and/or a button that allows a user to respond to the notification (e.g., a “Running Late” button). Notification screens and response buttons may be discussed in more detail below with regard to FIG. 6.

Notification response transmission module 412 may receive notification responses from a user of client computing device 400, e.g., via a device input mechanism 426. Notification response transmission module 412 may transmit notification responses 448 to a scheduling server. In some examples, notification response may be sent automatically, for example, soon after the notification response displays on the client device. Automatic sending of responses may be, for example, a notification setting. In some examples, notification responses may be sent in response to a user of the client device pressing a button included in the notification response (e.g., a button that reads, “You are running late, do you want to let the organizer know?”). The scheduling server may generate and/or transmit messages based on the notification responses. For example, if a user presses a “running late button” on a notification, the scheduling server may send a message to the organizer that reads, “I'm running a little late, start without me.” The message may also include information about how much time it will take the user to get to the event.

FIG. 5A is a flowchart of an example method 500 for generating event notifications based on learned traveling times between locations. Although execution of method 500 is described below with reference to scheduling server computing device 100 of FIG. 1, other suitable devices for execution of method 500 may be used, such as scheduling server computing device 300 of FIG. 3. Method 500 may be implemented in the form of executable instructions stored on a machine-readable storage medium, such as storage medium 120, and/or in the form of electronic circuitry. In alternate embodiments of the present disclosure, one or more steps of method 500 may be executed substantially concurrently or in a different order than shown in FIG. 5A. In alternate embodiments of the present disclosure, method 500 may include more or less steps than are shown in FIG. 5A. In some embodiments, one or more of the steps of method 500 may, at certain times, be ongoing and/or may repeat.

Method 500 may start at step 502 and continue to step 504, where scheduling server 100 may determine (e.g., via instructions 122) the location and/or movement of at least one user. At step 506, scheduling server 100 may verify (e.g., via instructions 124) the location of at least one event. At step 508, scheduling server 100 may learn (e.g., via instructions 126) travel times for at least one route. At step 510, scheduling server 100 may generate (e.g., via instructions 128) at least one notification and transmit the notification(s) to at least one client device. Method 500 may eventually continue to step 514, where method 500 may stop.

FIG. 5B is a flowchart of an example method 550 for facilitating the generation of (and receiving) event notifications based on learned traveling times between locations. Although execution of method 550 is described below with reference to scheduling server computing device 200 of FIG. 2, other suitable devices for execution of method 550 may be used, such as scheduling server computing device 400 of FIG. 4. Method 550 may be implemented in the form of executable instructions stored on a machine-readable storage medium, such as storage medium 220, and/or in the form of electronic circuitry. In alternate embodiments of the present disclosure, one or more steps of method 550 may be executed substantially concurrently or in a different order than shown in FIG. 5B. In alternate embodiments of the present disclosure, method 550 may include more or less steps than are shown in FIG. 5B. In some embodiments, one or more of the steps of method 550 may, at certain times, be ongoing and/or may repeat.

Method 550 may start at step 552 and continue to step 554, where client device 200 may determine (e.g., via instructions 222) the location and/or movement of itself (the client device). At step 556, the client device 200 may transmit (e.g., via instructions 224) location and/or movement information to a scheduling server. At step 558, the client device 200 may receive and display (e.g., via instructions 226) notification(s) received form the scheduling server. Method 550 may eventually continue to step 564, where method 550 may stop.

FIG. 6A is a flowchart of an example method 600 for generating event notifications based on learned traveling times between locations. Although execution of method 600 is described below with reference to scheduling server computing device 300 of FIG. 3, other suitable devices for execution of method 600 may be used, such as scheduling server computing device 100 of FIG. 1. Method 600 may be implemented in the form of executable instructions stored on a machine-readable storage medium, such as storage medium 120, and/or in the form of electronic circuitry. In alternate embodiments of the present disclosure, one or more steps of method 600 may be executed substantially concurrently or in a different order than shown in FIG. 6A. In alternate embodiments of the present disclosure, method 600 may include more or less steps than are shown in FIG. 6A. In some embodiments, one or more of the steps of method 600 may, at certain times, be ongoing and/or may repeat.

Method 600 may start at step 602 and continue to step 604, where scheduling server 300 may receive at least one digital map (e.g., from digital maps repository 320). At step 606, scheduling server 300 may receive location and/or movement information (e.g., information 340) from at least one client device and/or from at least one stationary device. At step 608, scheduling server 300 may determine (e.g., via module 302) the location and/or movement of at least one user. At step 610, scheduling server 300 may receive at least one event object (e.g., from event objects repository 322). At step 612, scheduling server 300 may verify (e.g., via module 304) the location of at least one event. At step 614, scheduling server 300 may learn (e.g., via module 306) travel times for at least one route. At step 616, scheduling server 300 may generate (e.g., via module 308) at least one notification. At step 618, scheduling server 300 may transmit the notification(s) (e.g., notification 344) to at least one client device. At step 620, scheduling server 300 may receive (e.g., via module 310) at least one notification response. At step 622, scheduling server 300 may handle (e.g., via module 310) the notification response(s). Method 600 may eventually continue to step 624, where method 600 may stop.

FIG. 6B is a flowchart of an example method 650 for facilitating the generation and receipt of event notifications based on learned traveling times between locations. Although execution of method 650 is described below with reference to scheduling server computing device 400 of FIG. 4, other suitable devices for execution of method 650 may be used, such as scheduling server computing device 200 of FIG. 2. Method 650 may be implemented in the form of executable instructions stored on a machine-readable storage medium, such as storage medium 220, and/or in the form of electronic circuitry. In alternate embodiments of the present disclosure, one or more steps of method 650 may be executed substantially concurrently or in a different order than shown in FIG. 6B. In alternate embodiments of the present disclosure, method 650 may include more or less steps than are shown in FIG. 6B. In some embodiments, one or more of the steps of method 650 may, at certain times, be ongoing and/or may repeat.

Method 650 may start at step 652 and continue to step 654, where client device 400 may detect (e.g., via location/proximity component(s) 420) other devices that are near device 400. At step 656, client device 400 may determine (e.g., via module 402) the location of itself (the client device). At step 658, client device 400 may receive data from at least one motion detection component 422. At step 660, client device 400 may determine (e.g., via module 404) the movement of itself (the client device). At step 662, the client device 400 may transmit (e.g., via module 406) location and/or movement information to a scheduling server. At step 664, client device 400 may interface with (e.g., via module 408) the scheduling server, for example, to transmit notification settings to the scheduling server. At step 666, the client device 400 may receive and display (e.g., via module 410) notification(s) received form the scheduling server. At step 668, the client device 400 may receive user input (e.g., via device input mechanism 426) in response to the notification(s). At step 670, client device 400 may transmit (e.g., via module 412) at least one notification response to the scheduling server. Method 650 may eventually continue to step 672, where method 650 may stop.

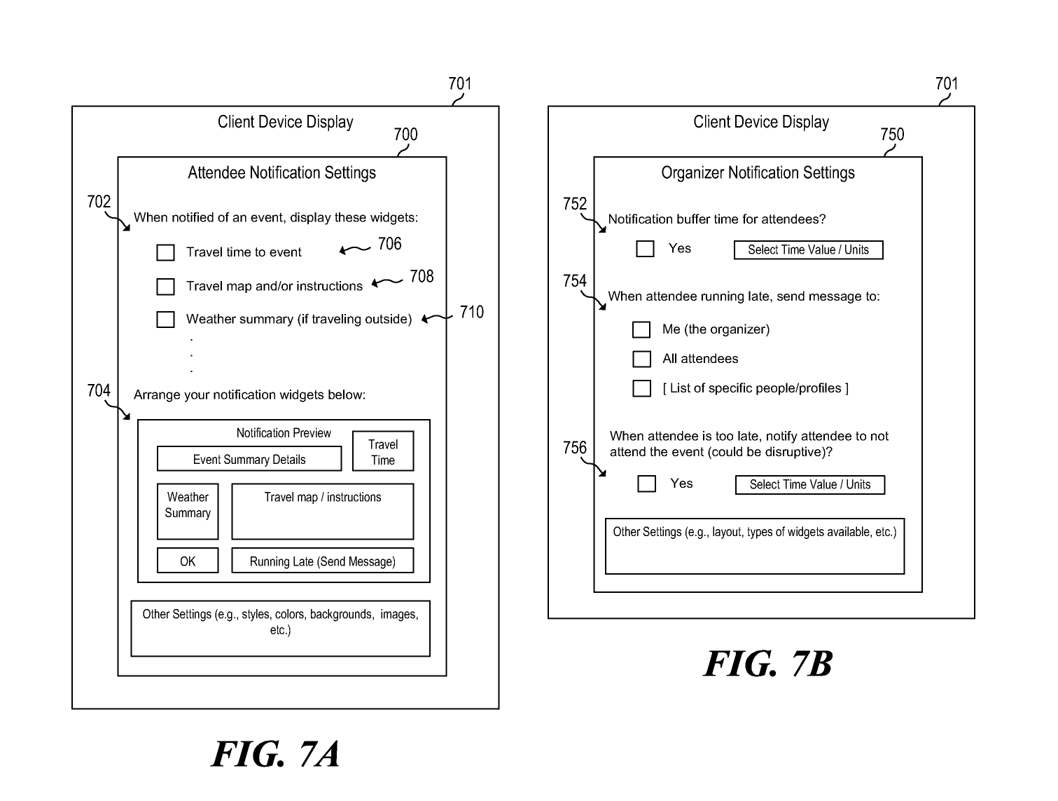

FIG. 7A is a diagram of an example user interface 700 that may be displayed on a device display 701 of a client device (e.g., device display 424 of client device 400). As illustrated in FIG. 7A, user interface 700 may be in a state that is ready to receive user input, for example, user input that may specify attendee notification settings. As described above, attendee notification settings, once specified, may be transmitted to a scheduling server, and may be stored in attendee notification settings repository 326. A user of a client device may specify these settings by interacting with the user interface (e.g., via a mouse or touchscreen).

User interface 700 may include a segment 702 that allows a user to select or indicate widgets that appear when the client device receives an event notification as described herein. User interface 700 may include a segment 704 that allows a user to specify how selected widgets should appear on the notification window when a notification is received. For example, as, can be seen in FIG. 7A, a user may select an option 706 to have the travel time to an event shown on the notification. As another example, a user may select an option 708 to have a travel map and/or travel instructions shown on the notification. As another example, a user may select an option 710 to have a weather summary shown on the notification. For every option (e.g., widget) selected by the user, a representation of the selected widget may be displayed in the notification preview in segment 704 to show the user how the widgets will be arranged when a notification displays. User interface 700 may accept user input (e.g., mouse or finger dragging) to move these representations around within the notification preview. User interface 700 may allow a user to set various other settings with regard to the way notification appear, for example, notification window styles, colors, background images or patterns, and the like.

FIG. 7B is a diagram of an example user interface 750 that may be displayed on a device display 701 of a client device (e.g., device display 424 of client device 400). As illustrated in FIG. 7B, user interface 750 may be in a state that is ready to receive user input, for example, user input that may specify organizer notification settings. As described above, organizer notification settings, once specified, may be transmitted to a scheduling server, and may be stored in organizer notification settings repository 328. A user of a client device may specify these settings by interacting with the user interface (e.g., via a mouse or touchscreen).

User interface 750 may include a segment 752 that allows a user to specify whether a notification buffer time should be used for attendees, and how long the buffer should be. A notification buffer may be a time that is used to generate a notification of an event prior to the event, for example, in addition to the travel time to an event. For example, if an attendee is located at a location that is a 7-minute walk to a meeting room, it may be useful for the attendee to receive an 8-minute notification, for example, to allow the attendee 1 minute to wrap up what the attendee is doing and 7 minutes to walk to the second meeting room. The 1 minute “wrap up” time may be the notification buffer.

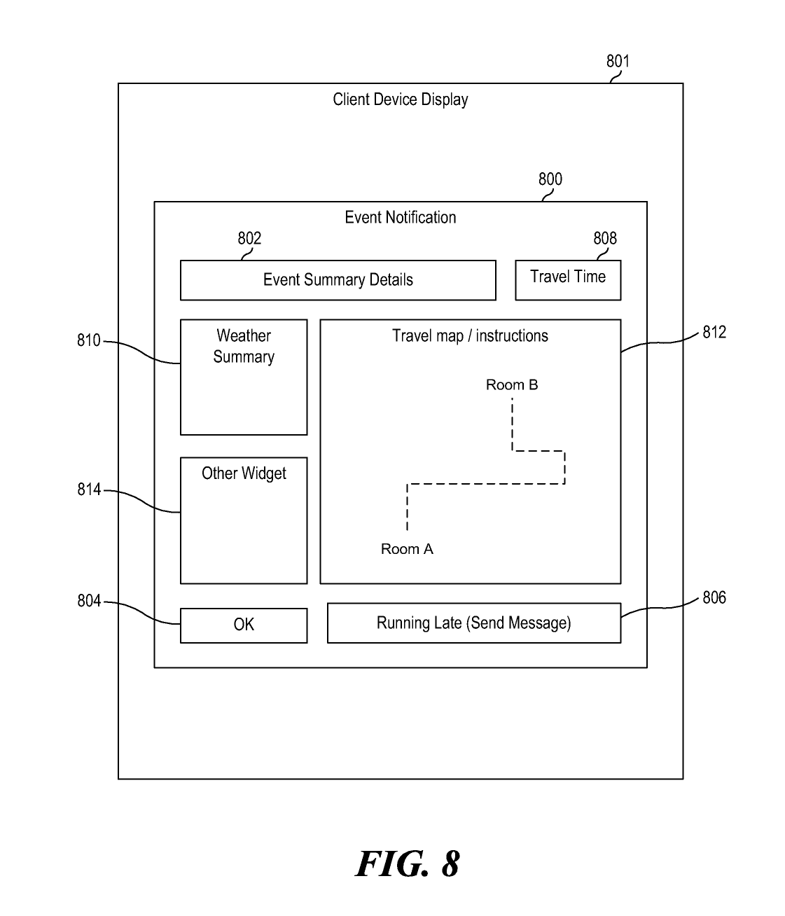

User interface 750 may include a segment 754 that allows a user to specify who should be messaged when an attendee is running late. Such message(s) may be sent in response to a notification response generated when a user presses a “running late” button on an event notification (e.g., as shown in FIG. 8). As shown in FIG. 7B, example recipients of such message may be the organizer, all attendees of the meeting and/or a list of specific recipients. User interface 750 may include a segment 756 that allows a user to specify whether to notify attendees who are running too late (e.g., a configurable time period) to a meeting that they should not bother coming (e.g., because it could be disruptive to an ongoing meeting). If such a setting is specified, a scheduling server may generate more than one notification, for example, one notification to remind the attendee of the meeting, and a subsequent notification to indicate that the attendee should not come. User interface 750 may allow a user to set various other settings with regard to the way notification appear, for example, notification window layouts, types of widgets available for display, or the like.

FIG. 8 is a diagram of an example notification 800 that may be displayed on a device display 801 of a client device (e.g., device display 424 of client device 400). A user of the client device may interact with the notification (e.g., via a mouse or touchscreen). Notification 800 may display (e.g., pop-up) on the screen of a client device, for example, in response to receiving a notification of an event from a scheduling server, as described herein. As illustrated in FIG. 8, notification 800 may include a summary 802 of the details of the event (e.g., title, date, time, content preview, etc.). Notification 800 may include an acknowledgement or “OK” button 804. A user may click or touch button 804 to cause the notification to disappear. Additionally, clicking or touching the OK button may cause a “notification seen” response to be sent to the scheduling server. Notification 800 may include a “running late” button 806, which may allow a user to indicate that the user will be late for the event. Clicking or touching button 806 may automatically cause a notification response to be sent to the scheduling server, and may cause one or more messages to be sent to recipients as described herein. Notification 800 may include an indication 808 of the travel time to the event. In some examples, this notification may be referred to as a widget.

Notification 800 may include at least one widget. One example widget may be a weather summary 810, which may indicate the weather outside, for example, if the suggested travel path to the meeting leads outside. Another example widget may be a travel map and/or travel instructions 812. Travel map/instructions 812 may display and/or explain a suggested route that an attendee may take to get from the attendee's current location to the event location. Notification 800 may include any number of other widgets (e.g., 814). As explained with regard to FIG. 7A above, an attendee and/or organizer (e.g., via notification settings) may configure the layout of the notification. For example, notification settings may specify the display location of the various widgets within the notification.

1. A scheduling system for event notifications based on learned traveling times between locations, the system comprising:
at least one processor to:
maintain an estimated travel time between a first location and a second location based on an actual travel time of a first client device between the first location and the second location;
determine a location of an event attendee based on location information received from a second client device associated with the event attendee;
determine a location of an event and an event time based on an event object;
identify the estimated travel time based on the first location being approximately the same as the location of the event attendee and the second location being approximately the same as the location of the event; and
automatically communicate an event notification for the event attendee based on the estimated travel time, the event notification to be presented to the event attendee using the second client device.

2. The system of claim 1, wherein the estimated travel time is based on actual travel times of multiple user client devices, and wherein the at least one processor is further to:
compute, for each user client device, one of the actual travel times based on a series of location data points received by the server computing device from the particular user client device; and
compute the estimated travel time based on an averaging function that receives as input the actual travel times of the multiple user client devices.

3. The system of claim 1, wherein the estimated travel time is determined by learning, over time, a typical traveling time between the first location and the second location, wherein the learning includes storing and analyzing multiple actual travel times.

4. The system of claim 1, wherein, to verify the event location, the at least one processor is further to:
access the event object to determine attendees of the event; and
determine if the attendees of the event are located at approximately the location of the event by receiving and analyzing location information from client devices associated with the attendees.

5. The system of claim 1, wherein the communication of the event notification occurs at a notification time that is earlier than the event time by at least the estimated travel time.

6. The system of claim 1, wherein the transmission of the event notification occurs at a notification time that is earlier than the event time by a time that is approximately the estimated travel time plus a configurable buffer time.

7. The system of claim 1, wherein the at least one processor is further to:
receive a notification response from the second client device;
automatically generate a message based on the notification response, wherein the message indicates whether the event attendee will be on time for the event; and
automatically transmit the message to at least one recipient, wherein the at least one recipient is pre-defined in the server computing device.

8. The system of claim 7, wherein the at least one processor is further to:
access the event object to determine potential recipients for the at least one recipient; and
access organizer notification settings to determine the at least one recipient from the determined potential recipients, wherein the organizer notification settings are configurable via a client device that is in communication with the server computing device.

9. A method for scheduling event notifications based on learned traveling times between locations, the method comprising:
determining an estimated travel time between a first location and a second location based on actual travel times of multiple user client devices between the first location and the second location, wherein each of the actual travel times is computed based on a series of location data points received from the respective user client device;
determining a location of an event attendee based on location information received from an attendee client device associated with the event attendee;
determining a location of an event and an event time based on an event object, wherein according to the event object, the event attendee should be at the event location at the event time; and
upon determining that the location of the attendee is approximately the same as the first location and the location of the event is approximately the same as the second location, communicating an event notification to the attendee based on the estimated travel time.

10. The method of claim 9, further comprising:
accessing attendee notification settings that indicate how the event notification is to appear for the event attendee; and
altering the event notification based on the attendee notification settings.

11. The method of claim 9, wherein the event notification indicates the event time and the estimated travel time between the location of the attendee and the location of the event.

12. The method of claim 11, wherein the event notification further indicates at least one of the following:
travel instructions that describe how to travel between the location of the attendee and the location of the event;
a travel map that shows how to travel between the location of the attendee and the location of the event; and
a weather summary that shows the status of outdoor weather for any portions of a suggested travel path between the location of the attendee and the location of the event.

13. The method of claim 9, wherein determining the estimated travel time includes using an averaging function that receives as input the actual travel times of the multiple user client devices.

14. A machine-readable storage medium encoded with instructions executable by a processor of a client computing device for event notifications based on learned traveling times between locations, the machine-readable storage medium comprising:
instructions for determining, via a location component, the location of the client computing device in relation to the at least one other device, wherein the location component detects the presence of other devices and detects the proximity between the location component and the other devices;
instructions for transmitting, to a scheduling server, location information that indicates the location of the client computing device;
instructions for receiving, from the scheduling server, an event notification related to an event, wherein the event notification is based on the location information, a location of the event, a starting time of the event and an estimated travel time to the event, wherein the estimated travel time is based on at least one actual travel time of at least one user client device between the location of the client computing device and the location of the event; and
instructions for automatically displaying, on a display of the client computing device, the event notification.

15. The machine-readable storage medium of claim 14, wherein at least one of the at least one other device is a stationary device that includes a location component that detects the presence of client computing devices.

16. The machine-readable storage medium of claim 14, further comprising:
instructions for receiving, via an input mechanism of the client computing device, a one-touch input that indicates acknowledgement of the event notification or that a user of the client computing device will be late to the event; and
instructions for transmitting, to the scheduling server, a notification response based on the one-touch input.

17. The machine-readable storage medium of claim 14, further comprising instructions for specifying and transmitting, to the scheduling server, notification settings, wherein the notification settings are for use in determining, at the scheduling server, how the event notification is generated and/or transmitted to the client computing device.
